(19) United States
(12) Patent Application Publication
(10) Pub. No.: US 2010/0206954 A1
(43) Pub. Date: Aug. 19, 2010

(54) MAP DISTANCE CALCULATOR

(76) Inventor: Henricus Antonius Kemps, Western Australia (AU)

Correspondence Address: NIXON & VANDERHYE, PC, 901 NORTH GLEBE ROAD, 11TH FLOOR, ARLINGTON, VA, 22203, US

(21) Appl. No.: 12/668,615

(22) PCT Filed: Jun. 30, 2008
(86) PCT No.: PCT/AU2008/000963

§ 371 Date: Jan. 11, 2010

(30) Foreign Application Priority Data
Jul. 10, 2007 (AU) 2007903719
Feb. 22, 2008 (AU) 2008900865

(51) Int. Cl. G06G 1/06; G06G 1/12; G01B 3/02

(52) U.S. Cl. 235/70 A

(57) ABSTRACT

A map distance calculator including a linear scale that to measure a specified distance on a map such as, for example, a scaled map of a golf course. The map distance calculator includes a double logarithmic scale that can be moved relative to the linear scale to easily calibrate the calculator 40 to a scaled map. The linear scale is printed on a substantially planar base member in the form of a rectangular sleeve member. A first part of the double logarithmic scale is printed on a sliding member that is slidably coupled to the sleeve member. The sleeve member is formed with an elongate window in its upper face extending adjacent to and parallel with the linear scale. A second part of the double logarithmic scale is printed along an edge of the window. The map distance calculator can be used on a map with a unique scale and subsequently used to directly read off the actual distance.

### FIELD OF THE INVENTION

The present invention relates to a distance calculator for calculating the actual distance from a scaled map and relates particularly, though not exclusively, to a device that can be used by golfers for calculating the distance required to hit a golf ball on a golf course before choosing a club.

### BACKGROUND TO THE INVENTION

Golf continues to grow in popularity as a sport around the world and new golf courses are being created every day. A typical golf course has at least nine holes, although most golf courses consist of eighteen holes. The course consists of a series of holes, each being surrounded by low cut grass referred to as the green. The term “hole” can also be used to refer to the distance from the tee to the green. The aim is to hit the ball into each hole around the course in sequence, using the least number of strokes.

After teeing off, the ball may come to rest on the fairway or in the rough (in exceptional cases it may land on the green on the first stroke). The player then hits the ball again from where it came to rest to the green. Playing the ball from the fairway is preferable as fairway grass is shorter and more even, allowing the player to cleanly strike the ball. Whereas playing from the rough is more difficult, since the grass in the rough is generally longer, and there may be obstacles such as trees in the rough, which may affect the flight of the ball.

While many holes are designed in a straight line from the tee-off point to the green, some of the holes may bend either to the left or to the right. This is called a “dogleg”, as it is similar in shape to the profile of a dog's hind leg. If the hole angles to the left it is called a “dogleg left”, and if it angles to the right it is called a “dogleg right.” Less commonly a hole's direction can have two bends in it, in which case it is called a “double dogleg.” Dogleg holes are more difficult to play as the player cannot normally see the green from the tee. Therefore it is necessary to carefully estimate where to hit the ball along a first section of the hole, so as to position it most advantageously for subsequent strikes. The player may refer to a small, scaled map usually provided on the reverse side of the scoring card to see the shape of a dogleg hole and to estimate the distance. Based on this estimate, the appropriate club can be selected to strike the ball the required distance.

The map of the golf course provided on the reverse side of the scoring card is scaled to fit onto the card and therefore tends to use a unique, non-standard scale. Sometimes the scale is printed on the card, however even if the scale is not provided, the player is informed of the total length of each hole with appropriate signage. Using this information the player or his/her caddy can calculate the scale by measuring the length of each section of the hole on the map, adding these lengths together and then dividing the total by the actual distance as indicated by signage. Employing this scale the player or caddy can then determine the length of each section of the hole, as shown on the map, to aid in the selection of the best club to use.

The present invention was developed with a view to providing an easy-to-use distance calculator for quickly determining the actual distance required to hit a golf ball from a map of the golf course before choosing a club. It will be apparent that the invention also has other applications where it is desired to be able to quickly calculate the actual distance on land or water from a scaled map, particularly over relatively flat terrain.

References to prior art in this specification are provided for illustrative purposes only and are not to be taken as an admission that such prior art is part of the common general knowledge in Australia or elsewhere.

### SUMMARY OF THE INVENTION

According to one aspect of the present invention there is provided a map distance calculator for calculating the actual distance from a scaled map, the calculator comprising:

a linear scale that can be used to measure a specified distance on the map; and,
a double logarithmic scale that can be moved relative to the linear scale to easily calibrate the calculator to a map with a unique scale and subsequently used to directly read off the actual distance corresponding to the specified distance on the map.

In one embodiment the linear scale is printed on a substantially planar base member that can be placed flat on the map. Preferably a first part of the double logarithmic scale is printed on an elongate sliding member that is slidably coupled to the base member. Preferably a second part of the double logarithmic scale is printed on the base member. In an alternate form of the invention, the first part of the double logarithmic scale is printed on the base member, and the second part of the logarithmic scale is printed on the elongate sliding member.

In a preferred embodiment the substantially planar base member is in the form of a rectangular sleeve member comprising an upper face and a lower face, at least the upper face being substantially transparent. Advantageously the sliding member is in the form of a rectangular card member, the card member being approximately the size of a business card or credit card, which is slidably received within the sleeve member.

Advantageously the linear scale is printed along one edge of the sleeve member. Preferably the sleeve member is formed with an elongate window extending adjacent to and parallel with the linear scale. Preferably the first part of the double logarithmic scale is printed along a longitudinal edge of the card member, and the second part of the double logarithmic scale is printed along an edge of the window in the sleeve member. In an alternate form of the invention, the first part of the double logarithmic scale is printed along an edge of the window in the sleeve member, and the second part of the double logarithmic scale is printed along the longitudinal edge of the card member. Preferably the sleeve member is formed with semi-circular cut-outs at each open side, to permit the card member to be gripped by the fingers when slidably moving the card member within the sleeve member. Optionally there may be an additional semi-circular cut-out at a lower edge of the card which may comprise a stopper means for securing the sliding member in position within the sleeve member.

In an alternative embodiment the substantially planar base member is in the form of a rectangular card member, the card member being approximately the size of a business card or credit card, so as to be easily stored in, for example, a wallet. Preferably the card member is formed with a groove in which said sliding member is slidably received. Preferably a fastening means is provided for temporarily fixing the sliding member in a desired position relative to the card member. In one embodiment said fastening means is a tightening screw that can be manually tightened or loosened to fix or move the sliding member in position.

Advantageously the linear scale is printed along one edge of the card member. Preferably the first part of the double logarithmic scale is printed along a longitudinal edge of the sliding member, and the second part of the double logarithmic scale is printed along an edge of the groove in the card member. Alternatively, the first part of the double logarithmic scale is printed along an edge of the groove in the card member, and the second part of the double logarithmic scale is printed along a longitudinal edge of the sliding member.

Typically the linear scale has uniform intervals spaced at one millimetre increments (or tenths of inch increments). Typically the double logarithmic scale has non-uniform intervals indicating the actual distance measured in metres.

According to another aspect of the present invention there is provided a card member for a map distance calculator, for calculating the actual distance from a scaled map, the card member being of rectangular shape and being approximately the size of a business card or credit card, and wherein a first part of a double logarithmic scale for the map distance calculator is printed on the card member. In an alternative form, the second part of the double logarithmic scale is printed on the card member.

The present invention further comprises a substantially planar, rectangular sleeve member having two open sides for slidably retaining a card member therein, the sleeve member comprising an elongate window extending adjacent to and parallel to an upper edge of the sleeve member, two cut-out portions at each open side of the sleeve member, a third cut-out portion in the lower edge of the sleeve member, and a gripping means for retaining the card member in the sleeve member. Typically the gripping means is in the form of a pair of friction pads forming the lower face of the sleeve member.

Throughout the specification, unless the context requires otherwise, the word “comprise” or variations such as “comprises” or “comprising”, will be understood to imply the inclusion of a stated integer or group of integers but not the exclusion of any other integer or group of integers. Likewise the word “preferably” or variations such as “preferred”, will be understood to imply that a stated integer or group of integers is desirable but not essential to the working of the invention.

### BRIEF DESCRIPTION OF THE DRAWINGS

The nature of the invention will be better understood from the following detailed description of several specific embodiments of the map distance calculator, given by way of example only, with reference to the accompanying drawings, in which:

FIG. 1 shows a plan view of part of a golf course that includes several dogleg holes;

FIG. 2 is a plan view of a first embodiment of a map distance calculator according to the invention;

FIGS. 3a to 3c show a plan view and an end view of a planar base member, a sliding member and a fastening means respectively of the map distance calculator of FIG. 2;

FIG. 4 illustrates a first step in a preferred method of calculating the actual length of a section of a dogleg hole using the map distance calculator of FIG. 2;

FIG. 5 illustrates a second step in a preferred method of calculating the actual length of a section of a dogleg hole using the map distance calculator of FIG. 2;

FIG. 6 illustrates the step of calibrating the map distance calculator of FIG. 2 on an actual scaled-down map of a golf course;

FIG. 7 illustrates the step of calculating the length of one section of a dogleg hole, using the map distance calculator of FIG. 2, on the same scaled-down map illustrated in FIG. 6;

FIGS. 8 and 9 are plan views of a second embodiment of a map distance calculator according to the invention;

FIGS. 10 to 12 show a planar base member, a sliding member and a fastening means respectively of the map distance calculator of FIGS. 8 and 9;

FIG. 13 is a plan view of a third embodiment of a map distance calculator according to the invention;

FIG. 14 is a plan view of a planar base member of the map distance calculator of FIG. 13;

FIG. 15 is an end view of the planar base member of FIG. 14;

FIG. 16 is a plan view of a sliding card member of the map distance calculator of FIG. 13;

FIGS. 17a and 17b illustrate a fourth embodiment of the map distance calculator of the invention;

FIGS. 18a to 18c are front perspective views of the sleeve member of the map distance calculator of FIG. 17; and,

FIGS. 18d to 18f are back perspective views of the sleeve member of the map distance calculator of FIG. 17.

### DETAILED DESCRIPTION OF PREFERRED EMBODIMENTS

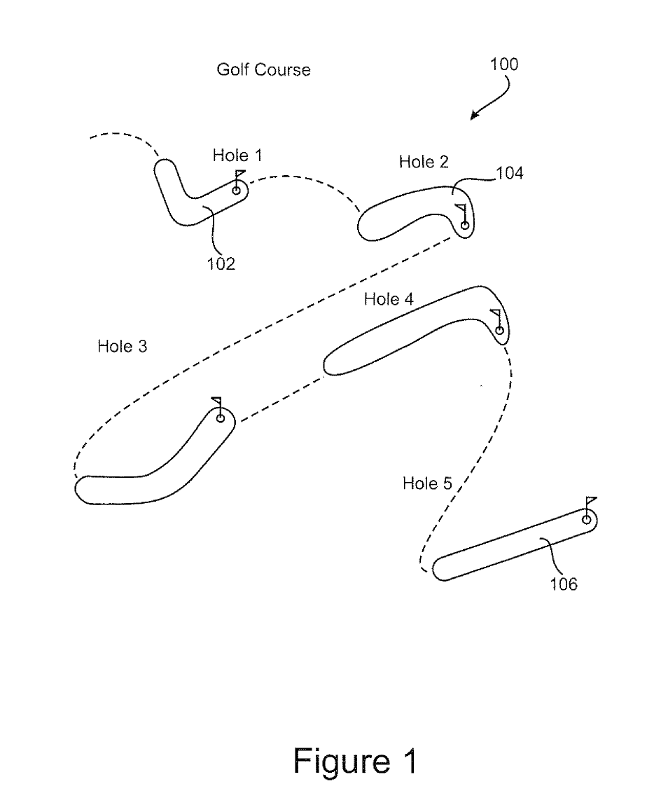

FIG. 1 is a schematic drawing showing in plan view part of a golf course 100 that includes several dogleg holes. Only five holes are shown, and of these four are dogleg holes. The first hole 102 is a dogleg left, whereas the second hole 104 is a dogleg right. The other holes are of various shapes and lengths, with only the fifth hole 106 having a straight fairway. When playing holes 102 and 104 the green will not typically be visible to the player from the tee. Therefore it is desirable, in such cases, to be able to calculate the actual distance along at least the first section of the dogleg so as to be able to determine the best club to use for that section.

Maps for golf courses are known to be an excellent tool for golfers and many golf courses around the world provide them on the back of their scoring cards. In addition, more and more golfers, particularly visiting ‘weekend golfers’ from overseas, travel to specific courses bringing aerial photographs (obtained through Google Earth) with them. Whether they are provided on the back of a scoring card or printed out at home, these maps are typically scaled to fit the scoring card/print card and therefore tend to have unique scales. The present invention provides an easy-to-use map distance calculator for quickly determining the actual distance required to hit a golf ball from a scaled map of the golf course so as to facilitate the correct choice of club. However the invention also has other applications where it is desired to be able to quickly calculate the actual distance on land or water from a scaled map, particularly over relatively flat terrain.

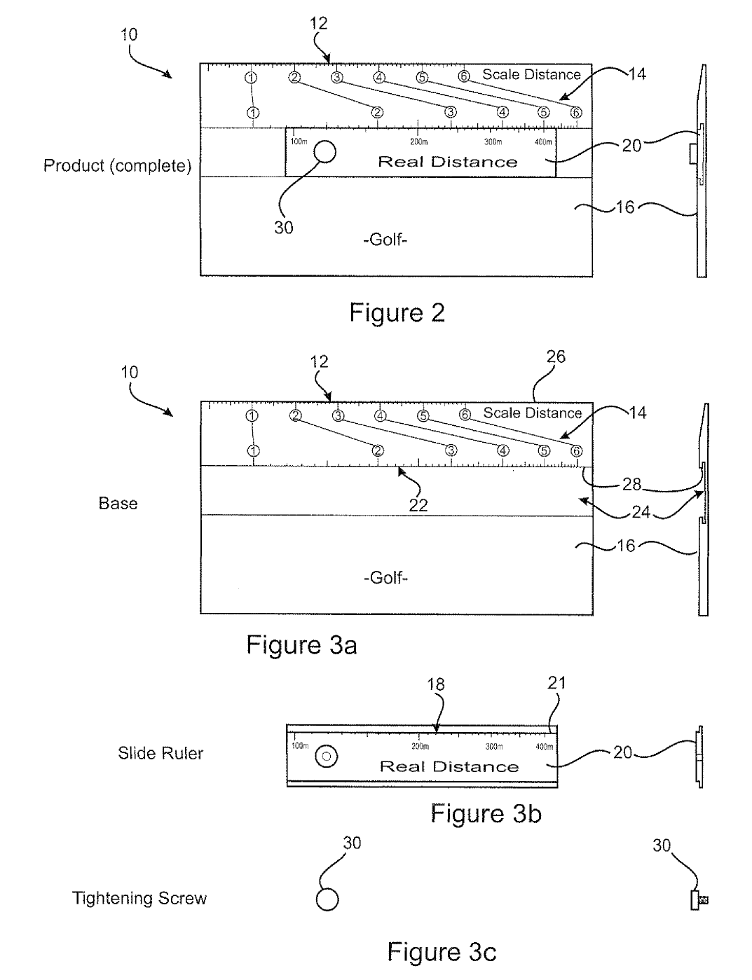

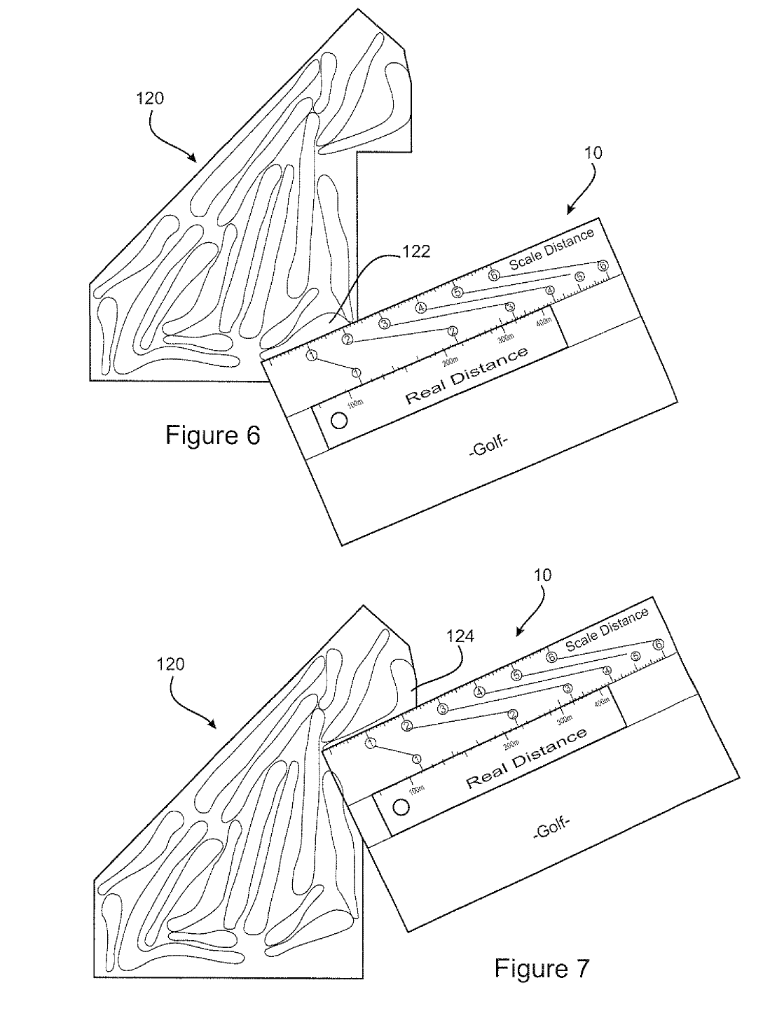

A preferred embodiment of the map distance calculator 10 in accordance with the invention, as illustrated in FIGS. 2 to 7, comprises a linear scale 12 that can be used to measure a specified distance on a map such as, for example, a map of a golf course (see FIGS. 6 and 7). The map distance calculator 10 further comprises a double logarithmic scale 14 that can be moved relative to the linear scale 12 to easily calibrate the calculator 10 to a range of maps with unique scales and subsequently used to directly read off the actual distance corresponding to the specified distance on the map.

In the illustrated embodiment the linear scale 12 is printed on a substantially planar base member 16 that can be placed flat on a map. In this embodiment the base member is in the form of a rectangular card member 16, the card member 16 being approximately the size of a business card or credit card, so as to be easily stored in, for example, a wallet. The map distance calculator 10 may in fact perform a dual function as a business card, which can be given to selected or prospective clients as a corporate gift (see FIGS. 6 and 7). The planar base member 16 may be made from a cardboard material, or from a suitably rigid or semi-rigid moulded plastics material.

Preferably the map distance calculator 10 further comprises an elongate sliding member 20 that is slidably coupled to the base member 16. As can be seen most clearly in FIG. 3a, the card member 16 is formed with a groove 24 in which the sliding member 20 is slidably received. The sliding member 20 may also be made from a cardboard material, or from a suitably rigid or semi-rigid moulded plastics material.

Advantageously the linear scale 12 is printed along one edge 26 of the card member 16. Preferably a first part 18 (see FIG. 3b) of the double logarithmic scale 14 is printed on an elongate sliding member 20 that is slidably coupled to the base member 16. More preferably the first part 18 of the double logarithmic scale 14 is printed along a longitudinal edge 21 of the sliding member 20. Preferably a second part 22 of the double logarithmic scale 14 is printed on the base member 16. More preferably the second part 22 of the double logarithmic scale 14 is printed along an edge 28 of the groove 24 in the card member 18.

In the illustrated embodiment the linear scale 12 has uniform intervals spaced at one millimetre increments, whereas the double logarithmic scale 14 has non-uniform intervals indicating the actual distance measured in metres. The double logarithmic scale is designed to convert the distance measured on the map in millimetres into the actual distance on the golf course measured in metres. The linear scale can of course have uniform intervals spaced at parts of inches if appropriate.

Preferably a fastening means 30 is provided for temporarily fixing the sliding member 20 in a desired position relative to the card member 16, for example following calibration. In this embodiment the fastening means is a tightening screw 30 (see FIG. 3c) that can be manually tightened or loosened to fix or move the sliding member 20 in position relative to the groove 24.

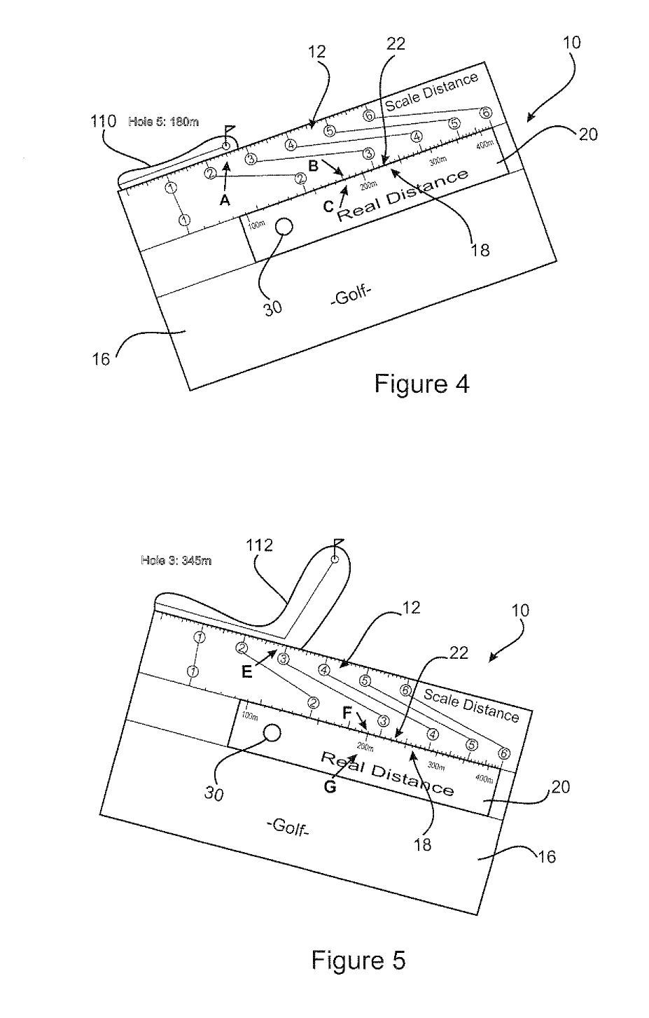

A preferred method of calibrating the map distance calculator 10, and subsequently using it to calculate the actual distance of a section of a dogleg hole on a golf course, will now be described with reference to FIGS. 4 to 7:

calibration

First loosen the tightening screw 30 and then lay the base member 16 on the map with the linear scale 12 against the map scale. If the map does not have a scale, (like on the back of a typical golf scoring card) then lay the base member 16 with the linear scale 12 overlying a trajectory of which the distance is known. Thus for example, as shown in FIG. 4, the linear scale 12 can be used to measure the length on the map of a straight Par 3 hole 110. The length of the Par 3 hole 110 is known to be 180 m. The length on the linear scale 12, in this case 2.5 cm (midway between points 1 and 2) at point A on the scale 12, corresponds to the actual distance 180 m.

Then use the second part 22 of the log scale as the linear distance in centimeters, and the first part 18 of the log scale on the sliding member 20 as the actual distance and set these against each other to match the scale of the map. Thus point A on the linear scale 12 corresponds to point B on the second part 22 of the double log scale 14. This point is known to be 180 m from the tee, and therefore point C on the sliding member 20 (showing the actual distance) can be aligned with point B to calibrate the calculator 10. Tighten the screw 30. The map distance calculator 10 is now calibrated for this particular map.

### Use

The calculator 10 may now be used to calculate the length of, for example, the first section of a dogleg hole 112 on the same map (see FIG. 5). Simply measure the desired map distance with the linear scale 12, which in this case is 2.8 cm marked as point E. This number is then followed onto the second part 22 of the log scale 14, which for 2.8 cm corresponds to point F on the second part 22 of the log scale. Finally the first part 18 of the log scale on the sliding member 20 is consulted to directly read off the actual distance at point G, which corresponds to 200 m. Based on this information, the player can select the appropriate club to play this section of the hole 112. The calculator 10 can be used in this way to measure any of the other holes on the same map without the need to recalibrate it. By leaving the tightening screw 30 tightened, so that the sliding member 20 does not move, the calculator 10 remains calibrated for this map.

FIGS. 6 and 7 illustrate the same process of calibrating and subsequently using the illustrated embodiment of map distance calculator 10 on an actual golf course map 120 as it would appear on the back of a score card. In FIG. 6 the calculator is first calibrated against a straight hole 122 of known length (220 m). In FIG. 7 the calculator 10 is used to measure the actual length of a first section of a dogleg left hole 124. The preferred method in both cases is substantially identical to that described in relation to FIGS. 4 and 5, and will not be described again in detail here.

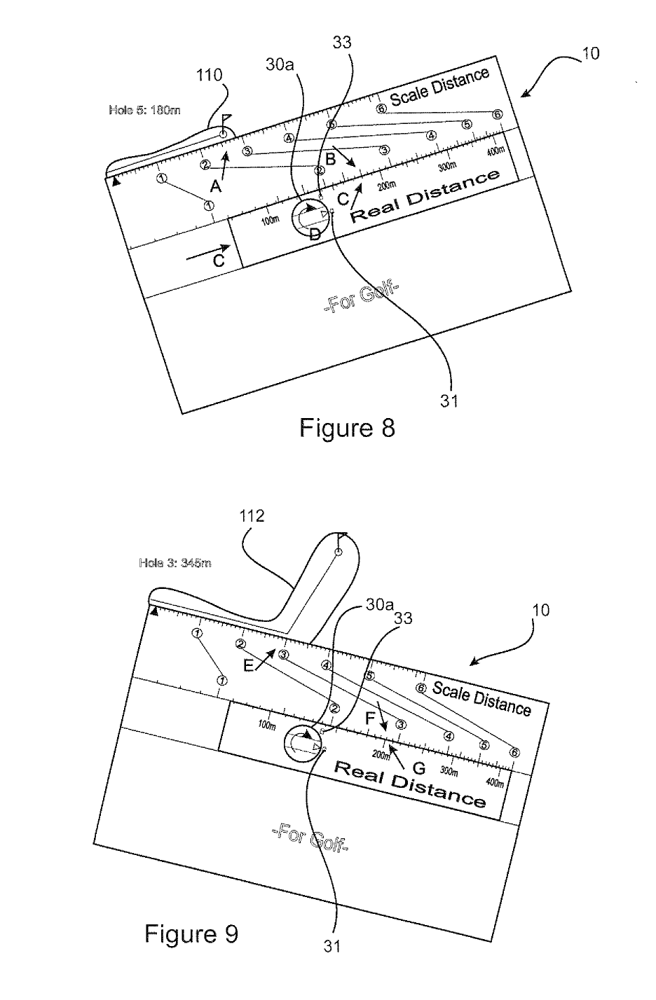

A second embodiment of the map distance calculator 10, as shown in FIGS. 8 to 12, resembles the fist embodiment in many respects and will not be described in detail again. Accordingly the parts of the second embodiment have been numbered in the same way as the parts shown in the first embodiment. In this embodiment the fastening means is the form of a cam member 34, pivotally received in an aperture 35 provided in the sliding member 20. It should be noted that the cam member 34 of the second embodiment can be locked into place after calibration to ensure that the sliding member 20 does not move when measuring a required distance. In this regard, it can be seen in FIGS. 8 and 9 that the cam member 34 has a locked position 31 and an unlocked position 33.

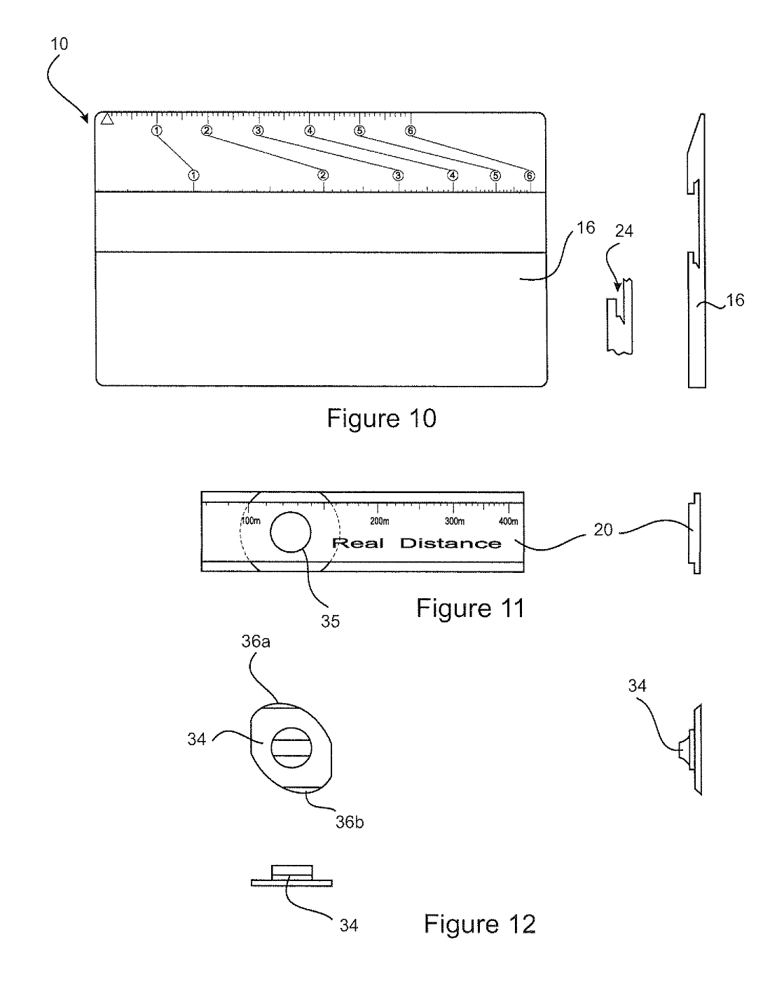

As can be seen most clearly in FIG. 12, the cam member 34 has an elliptical shape, two edges 36a and 36b of which are adapted to engage with the sides of the groove 16 to lock the sliding member 20 in the locked position 31. When the cam member 34 is pivoted to the unlocked position 33, the two edges 36 of the cam member 34 disengage the sides of the groove 16 and the sliding member 20 is free to move in the groove 16.

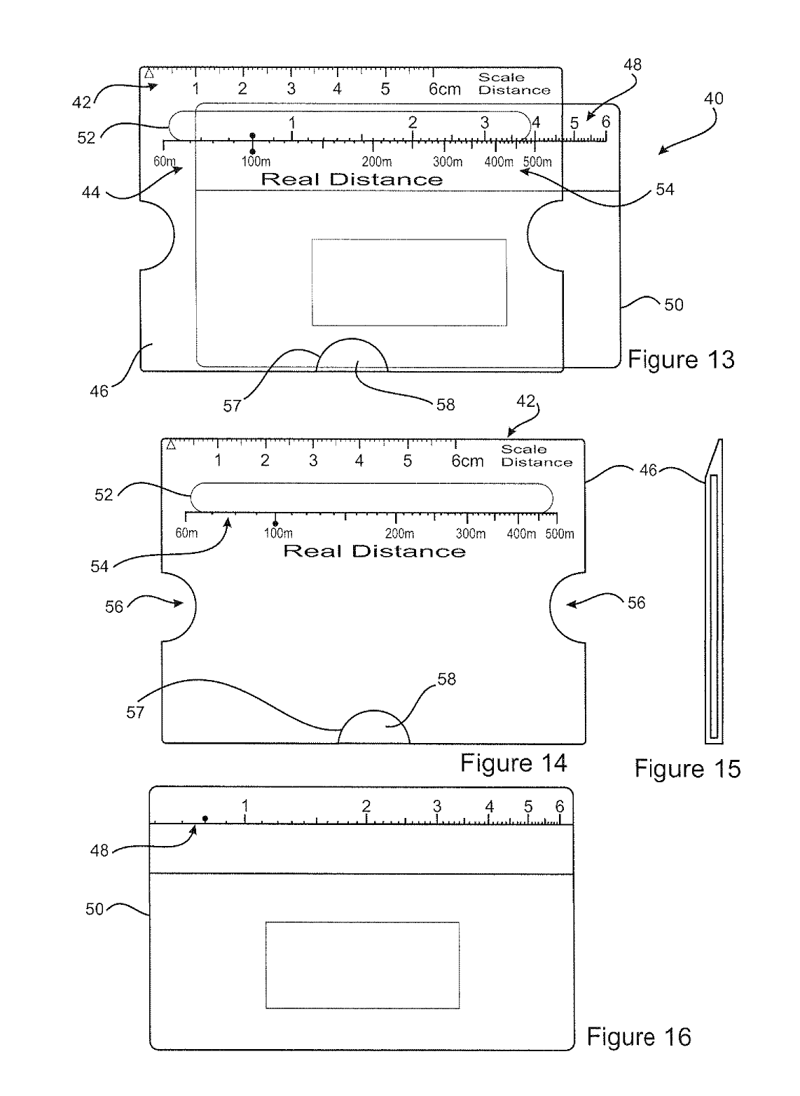

FIGS. 13 to 15 illustrate a third embodiment of the map distance calculator 40 according to the present invention. The map distance calculator 40 of this embodiment likewise comprises a linear scale 42, (labelled “Scale Distance” in FIGS. 13 and 14) that can be used to measure a specified distance on a map such as, for example, a scaled map of a golf course (similar to that shown in FIGS. 6 and 7). The map distance calculator 40 further comprises a double logarithmic scale 44 that can be moved relative to the linear scale 42 to easily calibrate the calculator 40 to a scaled map. The map distance calculator 40 can be used on a map with a unique scale and subsequently used to directly read off the actual distance corresponding to the specified distance on the map.

In the illustrated embodiment the linear scale 42 is printed on a substantially planar base member 46 that can be placed flat on a map. In this embodiment the base member is in the form of a rectangular sleeve member 46. The sleeve member 46 comprises an upper face and a lower face, at least the upper face being substantially transparent. In this embodiment the sleeve member is made from a substantially rigid plastics material and both the upper and the lower face are transparent. However the lower face of the sleeve member 46 may be substantially opaque. Advantageously the linear Scale 42 is printed on the upper face along one edge of the sleeve member 46.

Preferably a first part 48 of the double logarithmic scale 44 is printed on an elongate sliding member 50 that is slidably coupled to the sleeve member 46. In this embodiment the sliding member is in the form of a rectangular card member 50, the card member 50 being approximately the size of a business card or credit card, which is slidably received within the sleeve member 46. The card member 50 may be made from a cardboard material, or from a suitably rigid or semi-rigid plastics material, so as to be easily stored in, for example, a wallet. The map distance calculator 40 and/or the card member 50 may perform a dual function as a business card, which can be given to selected or prospective clients.

Preferably the sleeve member 46 is formed with an elongate window 52 in its upper face extending adjacent to and parallel with the linear scale 42. Preferably the first part 48 of the double logarithmic scale 44 is printed adjacent a longitudinal edge on the card member 50, and a second part 54 (labelled “Real Distance” in FIGS. 13 and 14) of the double logarithmic scale 44 is printed along an edge of the window 52 on the sleeve member 46. When the card member 50 is slidably received in the sleeve member 46, the first part 48 of the log scale is visible through the window 52 and can be aligned with the second part 54 of the log scale. The second part 54 of the log scale enables the actual or real distance to be read off from the map distance calculator 40, when the card member 50 has been correctly calibrated to the scaled map. The preferred method of calibrating the map distance calculator 40, and subsequently using it to calculate the actual distance on a scaled map, is substantially identical to that described above with reference to FIGS. 4 to 7, and will not be described again.

Preferably the sleeve member 46 is formed with semi-circular cut-outs 56 at each open side, to permit the card member 50 to be gripped by the fingers when slidably moving the card member within the sleeve member. A third cut-out 57 is provided in a lower edge of the sleeve member 46 which is optionally provided with a rubber stopper means 58 to assist in securing the card member within the sleeve member 46.

As with the first embodiment, the linear scale 42 has uniform intervals spaced at one millimetre increments, whereas the double logarithmic scale 44 has non-uniform intervals indicating the actual distance measured in metres. The double logarithmic scale 44 is designed to convert the distance measured on the map in millimetres into the actual distance on a golf course measured in metres.

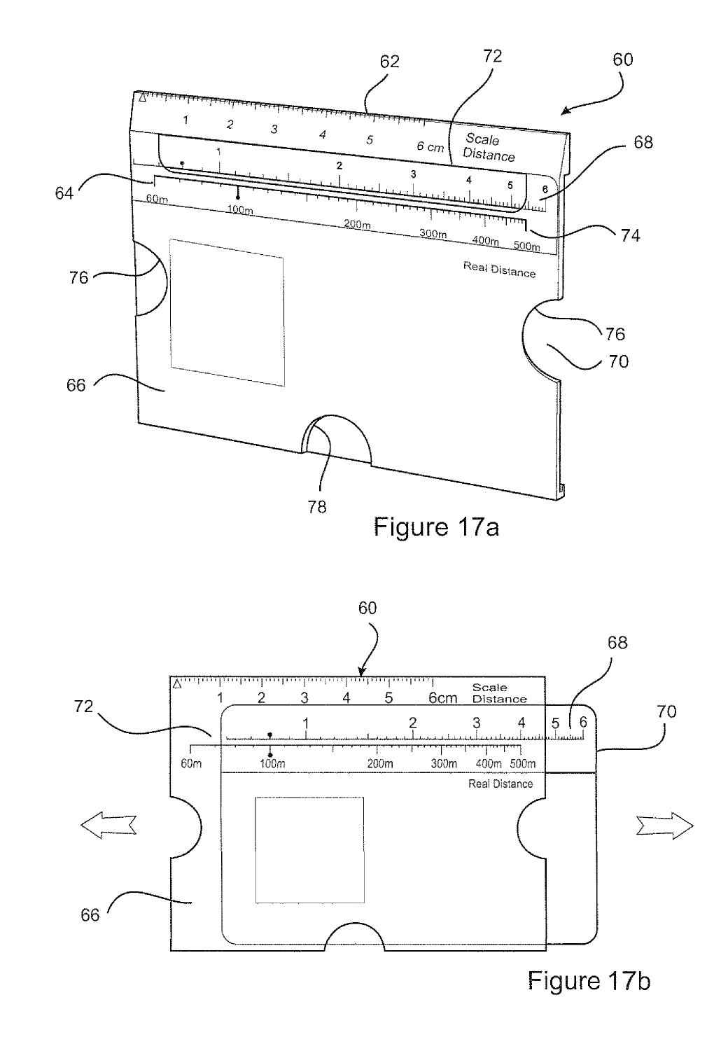

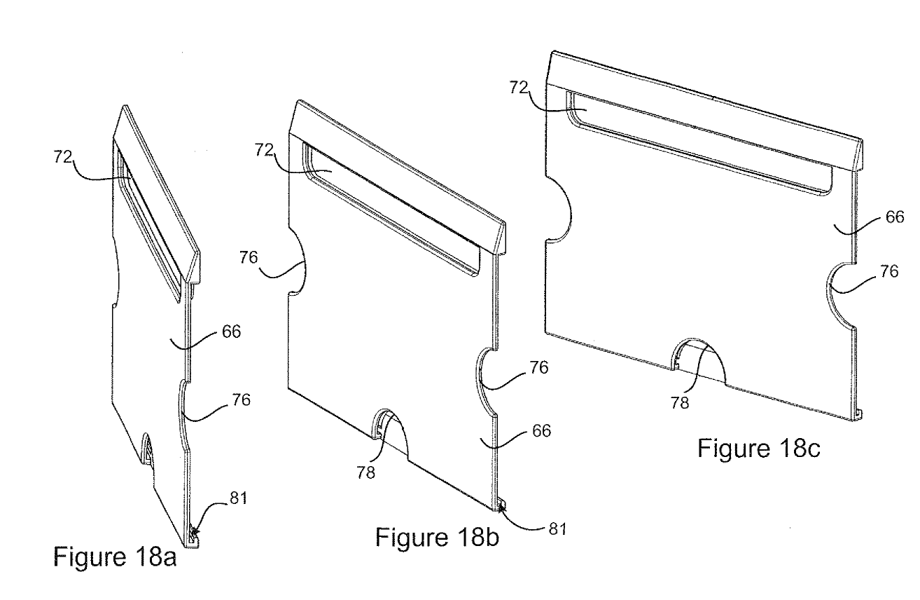

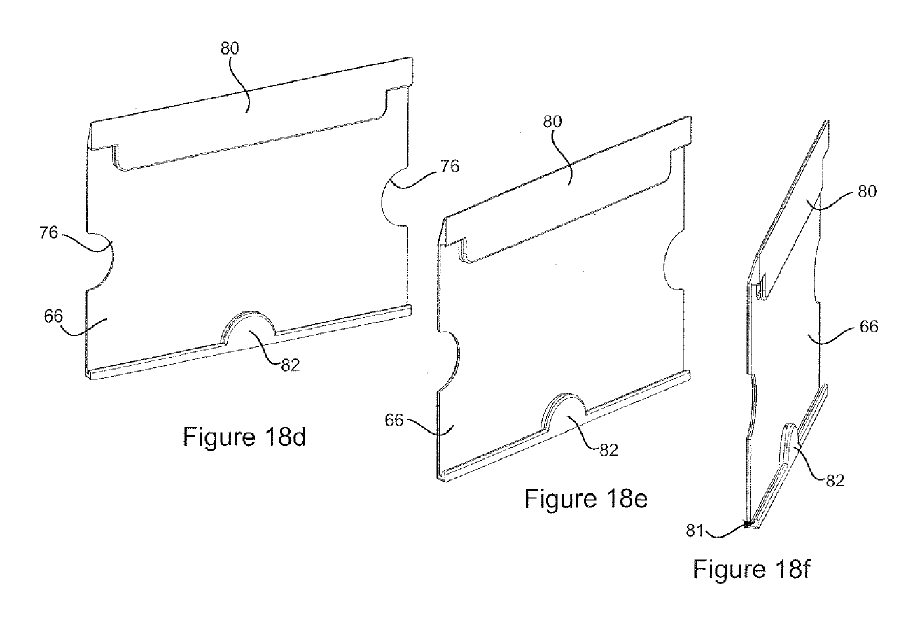

A fourth preferred embodiment of the map distance calculator 60 is shown in FIGS. 17a, 17b and 18a to 18f. The map distance calculator 60 is similar in some respects to that shown in the third embodiment illustrated in FIGS. 13 to 16. The map distance calculator comprises a linear scale 62, (labelled “Scale Distance” in FIGS. 17a and 17b) that can be used to measure a specified distance on a map such as, for example, a scaled map of a golf course. The map distance calculator 60 further comprises a double logarithmic scale 64 that can be moved relative to the linear scale 62 to easily calibrate the calculator 60 to a scaled map. The map distance calculator 60 is designed to be used on a map with a unique scale and subsequently used to directly read off the actual distance corresponding to the specified distance on the map.

In the illustrated embodiment the linear scale 62 is printed on a substantially planar base member 66 that can be placed flat on a map. In this embodiment the base member is in the form of a rectangular sleeve member 66 made from a substantially rigid plastics material. The sleeve member 66 comprises an upper face that is substantially transparent. Advantageously the linear scale 62 is printed on the upper face along one edge of the base member 66. On the back of the sleeve member 66 there is a retaining means in the form of an elongate friction pad 80 extending along most of a top edge of the Sleeve member 66, as can be seen more clearly in FIGS. 18d to 18f. A lip is provided on a bottom edge on the back of the sleeve members 66, so as to form a groove 81 extending along substantially the full length of the sleeve member 66. A second retaining means in the form of a friction pad 82 is provided about midway along this lip. The friction pads 80 and 82 help to retain a sliding member 70, which is slidably received in the groove 81, in the sleeve member 66 as shown in FIG. 17b.

Preferably a first part 68 of the double logarithmic scale 64 is printed on the elongate sliding member 70. In this embodiment the sliding member is in the form of a rectangular card member 70, the card member 70 being approximately the size of a business card or credit card. The card member 70 may be made from a cardboard material, or from a suitably rigid or semi-rigid plastics material, so as to be easily stored in, for example, a wallet. The map distance calculator 60 and/or the card member 70 may perform a dual function as a business card.

Preferably the sleeve member 66 is formed with an elongate window 72 in its upper face extending adjacent to and parallel with the linear scale 62. Preferably the first part 68 of the double logarithmic scale 64 is printed adjacent a longitudinal edge on the card member 70 (see FIG. 17b), and a second part 74 of the double logarithmic scale 64 is printed along an edge of the window 72 on the sleeve member 66 (see FIG. 17a). When the card member 70 is slidably received in the sleeve member 66, the first part 68 of the log scale is visible through the window 72 and is aligned with the second part 74 of the log scale. The second part 74 of the log scale enables the actual or real distance to be read-off from the map distance calculator 60, when the card member 70 has been correctly calibrated to the scaled map. The preferred method of calibrating the map distance calculator 60, and subsequently using it to calculate the actual distance on a scaled map, is substantially identical to that described above with reference to FIGS. 4 to 7, and will not be described again.

Preferably the sleeve member 66 is formed with semi-circular cut-outs 76 at each open side, to permit the card member 70 to be gripped by the fingers when slidably moving the card member 70 within the sleeve member 66. Additionally a third cut-out 78 may be provided in the upper face of the sleeve member 66, at the bottom edge, as shown in the FIGS. 17a and 18a to 18c. Each of the friction pads 80 and 82 has a rougher surface on its inner face to assist in gripping the card member 70 within the sleeve member. For ease of manufacture the upper friction pad 80 is of corresponding shape to that of the window 72 and in alignment with the window 72. For the same reason, the friction pad 82 is of corresponding shape to, and in alignment with, the third cut-out 78.

Now that preferred embodiments of the map distance calculator have been described in detail, it will be apparent that the embodiments provide a number of advantages, including the following:
(i) Because golfers are made aware of the total distance of each hole, the calculator can be calibrated even if a scale is not provided on a course map.
(ii) Golfers would benefit from a product that allows them to accurately determine the actual distance of a desired trajectory to facilitate the correct choice of a club.
(iii) Apart from its user benefits, the map distance calculator has many other advantages. For example, its low cost of manufacture, excellent dimensions, light weight, and relatively high surface area for advertising. These features make it a very marketable product for any company, as well as a suitable corporate gift.
(iv) In the embodiment having a card member such as a business card, advertising material may be printed on the business card which can serve as useful advertising space. Likewise advertising material may be printed on the base member.
(v) The invention provides a useful golf tool which may be readily carried in a wallet or shirt pocket.

It will be readily apparent to persons skilled in the relevant arts that various modifications and improvements may be made to the foregoing embodiments, in addition to those already described, without departing from the basic inventive concepts of the present invention. For example, the double log scale can be readily modified to cover longer distances, such as for hiking. Therefore, it will be appreciated that the scope of the invention is not limited to the specific embodiments described.

1. A map distance calculator for calculating the actual distance from a scaled map, the calculator comprising:
a linear scale that can be used to measure a specified distance on the map; and,
a double logarithmic scale that can be moved relative to the linear scale to easily calibrate the calculator to a map with a unique scale and subsequently used to directly read off the actual distance corresponding to the specified distance on the map.

2. A map distance calculator as defined in claim 1, wherein the linear scale is printed on a substantially planar base member that can be placed flat on the map.

3. A map distance calculator as defined in claim 2, wherein a first part of the double logarithmic scale is printed on a sliding member that is slidably coupled to the base member.

4. A map distance calculator as defined in claim 3, wherein a second part of the double logarithmic scale is printed on the base member.

5. A map distance calculator as defined in claim 2, wherein the first part of the double logarithmic scale is printed on the base member, and the second part of the logarithmic scale is printed on the elongate sliding member.

6. A map distance calculator as defined in claim 2, wherein the substantially planar base member is in the form of a rectangular sleeve member comprising an upper face and a lower face, at least the upper face being substantially transparent.

7. A map distance calculator as defined in claim 6, wherein the sliding member is in the form of a rectangular card member, the card member being approximately the size of a business card or credit card, which is slidably received within the sleeve member.

8. A map distance calculator as defined in claim 7, wherein the linear scale is printed along one edge of the sleeve member.

9. A map distance calculator as defined in claim 8, wherein the sleeve member is formed with an elongate window extending adjacent to and parallel with the linear scale.

10. A map distance calculator as defined in claim 9, wherein the first part of the double logarithmic scale is printed along a longitudinal edge of the card member, and the second part of the double logarithmic scale is printed along an edge of the window in the sleeve member.

11. A map distance calculator as defined in claim 9, wherein the first part of the double logarithmic scale is printed along an edge of the window in the sleeve member, and the second part of the double logarithmic scale is printed along the longitudinal edge of the card member.

12. A map distance calculator as defined in any one of claims 7 to 11, wherein the sleeve member is formed with semi-circular cut-outs at each open side, to permit the card member to be gripped by the fingers when slidably moving the card member within the sleeve member.

13. A map distance calculator as defined in claim 12, wherein an additional semi-circular cut-out is provided at a lower edge of the sleeve member comprising a stopper means for securing the sliding member in position within the sleeve member.

14. A map distance calculator as defined in claim 2, wherein the substantially planar base member is in the form of a rectangular card member, the card member being approximately the size of a business card or credit card, so as to be easily stored in, for example, a wallet.

15. A map distance calculator as defined in claim 14, wherein the card member is formed with a groove in which a sliding member is slidably received.

16. A map distance calculator as defined in claim 15, wherein a fastening means is provided for temporarily fixing the sliding member in a desired position relative to the card member.

17. A map distance calculator as defined in claim 16, wherein the fastening means is a tightening screw that can be manually tightened or loosened to fix or move the sliding member in position.

18. A map distance calculator as defined in any one of claims 14 to 17, wherein the linear scale is printed along one edge of the card member.

19. A map distance calculator as defined in claim 18, wherein the first part of the double logarithmic scale is printed along a longitudinal edge of the sliding member, and the second part of the double logarithmic scale is printed along an edge of the groove in the card member.

20. A map distance calculator as defined in claim 18, wherein the first part of the double logarithmic scale is printed along an edge of the groove in the card member, and the second part of the double logarithmic scale is printed along a longitudinal edge of the sliding member.

21. A map distance calculator as defined in claim 2, wherein the substantially planar base member is in the form of a rectangular sleeve member having two open sides for slidably retaining a card member therein.

22. A map distance calculator as defined in claim 21, wherein the sleeve member comprises a substantially transparent upper face with a retaining means provided on the back for slidably retaining the card member therein.

23. A map distance calculator as defined in claim 22, wherein the retaining means is in the form of a pair of friction pads, a first friction pad being provided along a top edge of the sleeve member and a second friction pad being provided along a bottom edge of the sleeve member.

24. A map distance calculator as defined in claim 23, wherein an elongate window is provided in the upper face of the sleeve member extending adjacent to and parallel to the top edge of the sleeve member.

25. A map distance calculator as defined in claim 24, further comprising two cut-out portions at each open side of the sleeve member and a third cut-out portion in the bottom edge of the sleeve member.

26. A map distance calculator as defined in claim 25, wherein the first friction pad is of corresponding shape to, and in alignment with, the elongate window, and the second friction pad is of corresponding shape to, and in alignment with, the third cut-out portion.

27. A map distance calculator as defined in any one of the preceding claims, wherein the linear scale has uniform intervals spaced at one millimetre increments, and the double logarithmic scale has non-uniform intervals indicating the actual distance measured in metres.

28. A map distance calculator substantially as herein described with reference to and as illustrated in any one or more of the accompanying drawings.
